(19) United States
(12) Patent Application Publication
(10) Pub. No.: US 2010/0257070 A1
(43) Pub. Date: Oct. 7, 2010

(54) Method and System for Presenting User-Desired Media Content

(75) Inventor: Krishna Prasad Panje, Bangalore (IN)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 12/738,523

(22) PCT Filed: Oct. 17, 2008
(86) PCT No.: PCT/US08/80248

§ 371 Date: May 27, 2010

(30) Foreign Application Priority Data
Oct. 19, 2007 (IN) 2191/DEL/2007

(51) Int. Cl. G06Q 30/00; G06F 3/048; G06F 15/16

(52) U.S. Cl. 705/27; 715/716; 709/219

(57) ABSTRACT

The present invention provides a method and system for presenting user-desired media content. The method and system includes receiving (504) media content at an electronic device. The media content includes a business-task list. Further, the method includes identifying (506) at least one business-task, based on inputs from a user of the electronic device. Moreover, the method includes presenting (508) the user-desired media content to the user of the electronic device. The user-desired media content pertains to at least one business-task.

The present invention generally relates to electronic devices, and more particularly, to a method and system for presenting user-desired media content at electronic devices.

### BACKGROUND OF THE INVENTION

In today's world, the use of electronic devices has become increasingly common. Examples of electronic devices include televisions (TVs), digital video recorders (DVRs), personal video recorders (PVRs), time-shift recorders, smart phones, computers, laptops, Personal Digital Assistants (PDAs), and so forth. These electronic devices play the media content received either from broadcasters or stored at these electronic devices. The media content can be video or audio content that can be in a digital or analog format.

The media content can include a video/audio clip or an advertisement, which may be of interest to a user watching the media content at the electronic device. The user may want to perform a business-task after watching a clip or an advertisement. For example, after watching an advertisement for a car, the user may want more information about that car with the intention of buying it. However, the media content may not provide information pertaining to the business-task the user wants to perform. Therefore, the promoter of the clip or advertisement may lose a business opportunity.

There exist various methods that address the problem of loss of a business opportunity due to the inability of the media content to enable the user to perform the desired business-task. One such method is to include information pertaining to the business-task the user may want to perform as metadata in between the media content. For example, a car advertisement may contain metadata with information pertaining to car dealers, promotional offers, the technical specifications of the car, and so forth, as text, an image, a video, etc. Thereby, the user can use this information to perform the desired business-task.

However, such information on metadata may require a large bandwidth, which may not be available to the user. Further, the creator of the metadata may not be able to create information related to all the business-tasks the user may want to perform. For example, if the user wants to obtain information pertaining to car dealers while watching the car advertisement, such information may not have been included in the metadata by its creator. Hence, the metadata fails to facilitate the business-task desired by the user, resulting in the loss of a business opportunity. Moreover, in the method mentioned above, a large database of metadata needs to be created and managed. Furthermore, by using this method, all the users get the same information on metadata, whereas they may need personalized information pertaining to the business-tasks they want to perform.

### BRIEF DESCRIPTION OF THE DRAWINGS

The accompanying figures, where like reference numerals refer to identical or functionally similar elements throughout the separate views, and which, together with the detailed description below, are incorporated in and form part of the specification, serve to further illustrate various embodiments and explain various principles and advantages, all in accordance with the present invention.

FIG. 1 illustrates an exemplary communication environment, where various embodiments of the present invention can be practiced;

FIG. 2 illustrates a block diagram of an electronic device, in accordance with an embodiment of the present invention;

FIG. 3 illustrates a block diagram of a media content server, in accordance with an embodiment of the present invention;

FIG. 4 illustrates a block diagram of a business process-enabler portal, in accordance with an embodiment of the present invention;

FIG. 5 is a flow diagram illustrating a method for presenting a user-desired media content, in accordance with an embodiment of the present invention; and

FIGS. 6 and 7 depict a flow diagram illustrating a method for presenting user-desired media content, in accordance with an embodiment of the present invention.

Skilled artisans will appreciate that elements in the figures are illustrated for simplicity and clarity and have not necessarily been drawn to scale. For example, the dimensions of some of the elements in the figures may be exaggerated, relative to other elements, to help in improving an understanding of the embodiments of the present invention.

### DETAILED DESCRIPTION

Before describing in detail the particular method and system for presenting user-desired media content at the electronic device, in accordance with various embodiments of the present invention, it should be observed that the present invention resides primarily in combinations of method steps related to the method and system for presenting user-desired media content. Accordingly, the apparatus components and method steps have been represented, where appropriate, by conventional symbols in the drawings, showing only those specific details that are pertinent for an understanding of the present invention, so as not to obscure the disclosure with details that will be readily apparent to those with ordinary skill in the art, having the benefit of the description herein.

In this document, the terms ‘comprises,’ ‘comprising’, or any other variation thereof, are intended to cover a non-exclusive inclusion, such that a process, method, article or apparatus that comprises a list of elements does not include only those elements but may include other elements that are not expressly listed or inherent in such a process, method, article or apparatus. An element proceeded by ‘comprises . . . a’ does not, without more constraints, preclude the existence of additional identical elements in the process, method, article or apparatus that comprises the element. The term ‘another,’ as used in this document, is defined as at least a second or more. The terms ‘includes’ and/or ‘having’, as used herein, are defined as comprising.

For one embodiment, a method for presenting user-desired media content is provided. The user-desired media content relates to at least one business-task that the user wants to perform. The at least one business-task includes all forms of commercial activity that the user can perform. The method includes receiving media content at an electronic device. The media content includes a business-task list. The business-task list includes at least one business-task that the user may want to perform. The method also includes identifying at least one business-task, based on inputs from a user at the electronic device. Moreover, the method includes presenting the user-desired media content to the user at the electronic device.

For another embodiment, an electronic device for presenting user-desired media content is provided. The user-desired media content relates to at least one business-task that the user wants to perform. The at least one business-task includes all forms of commercial activity that the user can perform. The electronic device includes a receiver that is configured to receive media content, which includes a business-task list. The business-task list includes at least one business-task that the user may want to perform. The electronic device also includes a processor that is configured to identify at least one business-task, based on inputs from a user. Moreover, the electronic device includes an output unit that is configured to present the user-desired media content to the user.

For yet another embodiment, a business process-enabler portal, enabling the transfer user-desired media content to an electronic device, is provided. The user-desired media content relates to at least one business-task that the user wants to perform. The at least one business-task includes all forms of commercial activity that the user can perform. The business process-enabler portal includes a receiver that is configured to receive information pertaining to at least one business-task identified by a user of the electronic device. The business process-enabler portal also includes a business processor that is configured to select the user-desired media content, based on the at least one business-task. Moreover, the business processor is configured to enable the transfer of the user-desired media content from a media content creator to the electronic device.

For another embodiment, a media content server for managing user-desired media content at an electronic device is provided. The user-desired media content relates to at least one business-task that the user wants to perform. The at least one business-task includes all forms of commercial activity that the user can perform. The media content server includes a receiver that is configured to receive information pertaining to at least one business-task identified by a user. The user identifies the at least one business-task while viewing the media content at the electronic device. The media-content server also includes a server processor that is configured to select the user-desired media content, based on the information pertaining to the at least one business-task. Moreover, the media content server includes a transmitter that is configured to transmit the user-desired media content to the electronic device.

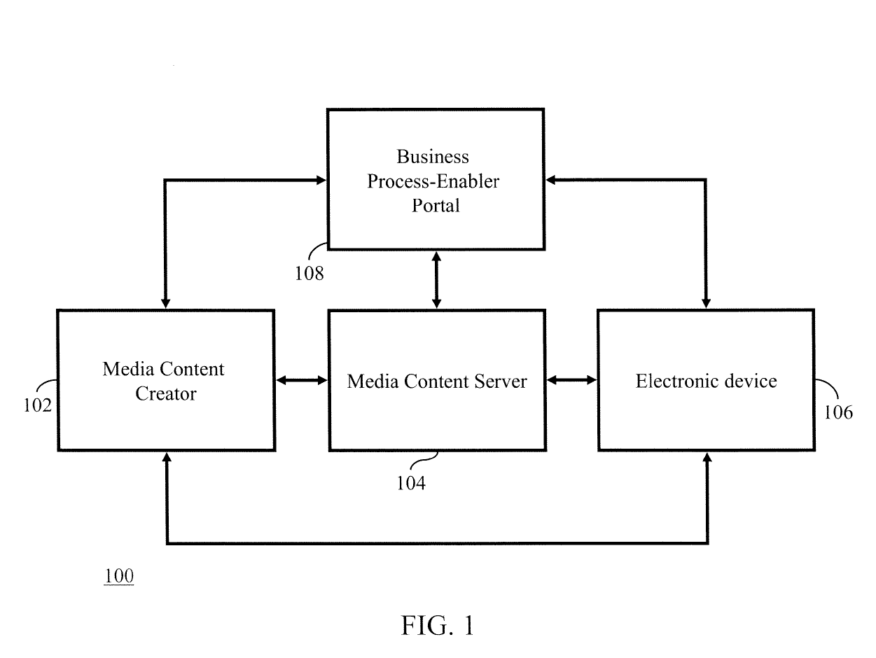

FIG. 1 illustrates an exemplary communication environment 100, where various embodiments of the present invention can be practiced. The exemplary communication environment 100 enables the presentation of user-desired media content to users. This user-desired media content is related to the at least one business-task the user desires to perform. The at least one business-task includes all forms of commercial activity that the user can perform while/after watching the media content. For example, after watching a movie clip, the user may want to purchase a digital versatile disk (DVD) of the movie. In this case, purchasing of the DVD is a commercial activity. Further in this example, the media content related to the purchase information about the DVD is the user-desired media content. Different forms of commercial activities can also include buying, leasing, renting a product, getting more information about the dealers of the product, getting to know other channels running programs similar to the media content being viewed by the user, getting more movies of actor in a particular program or a clip, and so forth.

User-desired media content can be media content that presents text, graphics, video or audio. The media content can have a program identification (ID) and a content ID included in it. The content has ID uniquely identifies the media content. Further, the media content has a program ID which contains an address of the storing location of the media content. The storing location can be, but not limited to, a web location, a frequency of transmission or program ID as present in the MPEG2 transport stream PID (program ID) etc.

Media content can be any video or audio content that is in a digital or analog format. The formats in which the video media content can be stored include, but are not limited to, National Television Standards Committee (NTSC), Phase Alternating Line (PAL), Sequential Color with Memory (SECAM), Motion Pictures Experts Group (MPEG), Advanced Systems Television Committee (ATSC), and Integrated Services Digital Broadcasting (ISDB). Examples of audio media content include MPEG audio layer-3 (mp3) audio, Windows Media Audio (WMA), RealAudio™, waveform audio format (way), and so forth. Although examples of media content have been mentioned above, one ordinarily skilled in the art would appreciate that the invention can be practiced with any other suitable media content format.

The exemplary communication environment 100 is shown to include a media content creator 102, a media content server 104, an electronic device 106, and a business process-enabler portal 108. The media content creator 102 stores and transmits the media content so that users can watch and/or listen to it. Examples of media content creator 102 include, but are not limited to, television and radio stations, satellite and cable systems, servers located in the Internet, and so forth. The media content creator 102 is also configured to store the user-desired media content. In addition to this, the media content creator 102 can transmit the media content and/or the user-desired media content to the media content server 104. The media content and/or the user-desired media content can be audio/video data. In an embodiment, the media content and/or the user-desired media content can be transmitted to the electronic device 106.

The media content server 104 receives the media content and/or the user-desired media content from the media content creator 102. The media content server 104 also manages the presentation of media content and/or the user-desired media content at the electronic device 106. The media content server 104 can be a head end or a server at the location of the cable service provider that maintains the media content and/or the user-desired media content to be streamed to the electronic device 106.

The electronic device 106 can receive the media content and/or the user-desired media content from either the media content creator 102, the media content server 104 or the business process-enabler portal 108. In an alternative embodiment, media content and/or the user-desired media content may be stored at the electronic device 106. The electronic device 106 can be a television (TV), a digital video recorder (DVR), a Set Top Box (STB), a personal video recorder (PVR), a time shift recorder, a radio set, a smart phone, a pager, a computer, a laptop, a Personal Digital Assistant (PDA), and so forth. The electronic device 106 can present the media content and/or the user-desired media content to the users.

A business process-enabler portal 108 can publish the information pertaining to the media content, the user-desired media content, and the users. The business process-enabler portal 108 can be a website on the Internet that can facilitate the presentation of media content desired by the users. For this purpose, the business process-enabler portal 108 receives the media content and/or the user-desired media content from the media content creator 102. Thereafter, the business process-enabler portal 108 transmits the media content and/or the user-desired media content to the media content server 104. The business process-enabler portal 108 can also transmit the media content and/or the user-desired media content to the electronic device 106. The business process-enabler portal 108 can also enable the media content server 104 and the electronic device 106 to retrieve the media content from the business process-enabler portal 108. For example, a website such as that of Apple™ iTunes™ can provide access to its users so that they can download video/audio from its database.

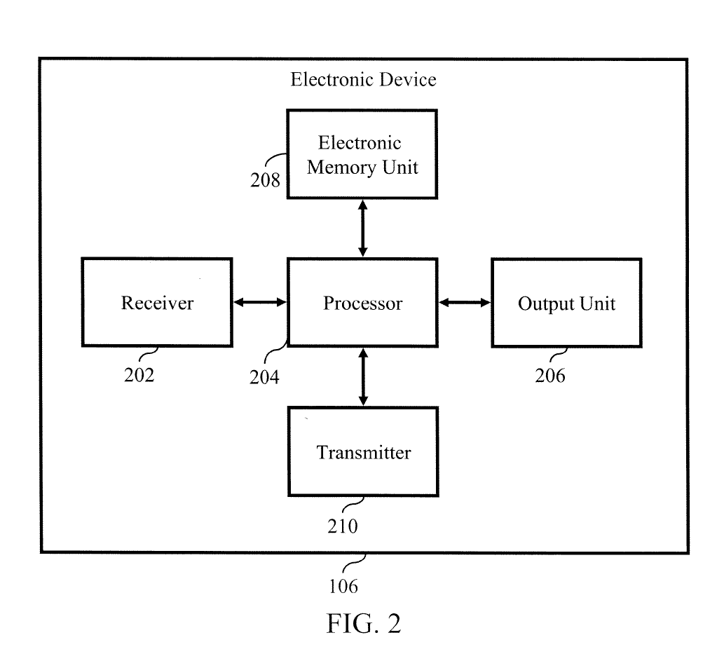

FIG. 2 illustrates a block diagram of an electronic device 106, in accordance with an embodiment of the present invention. The electronic device 106 includes a receiver 202, a processor 204, an output unit 206, an electronic memory unit 208, and a transmitter 210. The electronic device 106 presents media content to the users and can also present user-desired media content to them. The user-desired media content pertains to the business-task the user may want to perform while watching media content. For example, while watching an advertisement for a car, the user may want to know about the car loans available. Hence, in this case, the user-desired media content will pertain to information on car loans available in the market. The electronic device 106 can also store media content at the electronic memory unit 208.

The receiver 202 receives the media content to be presented at the electronic device 106. For example, users watching a program on television receive the program in the form of media content. The media content can be received from the media content creator 102, the media content server 104, the business process-enabler portal 108, and the electronic memory unit 208. The media content includes a business-task list, which includes a list of business-tasks the user may wish to perform while watching the media content. For example, after watching a movie clip, users may wish to purchase a DVD of the movie. Hence, the business-task “purchase DVD of the movie” can be included in the business-task list, in-between the advertisement, as metadata.

After the receiver 202 receives the media content, the output unit 206 presents the media content at the electronic device 106. The output unit 206 can be a display or speaker unit at the electronic device 106. For example, the output unit 206 can be a monitor, a cathode ray tube (CRT) display, a liquid crystal display (LCD), a speaker, earphones, and so forth. The output unit 206 also presents the business-task list for the user to select at least one business-task from the list. The business-task list can be presented to the users as a graphical user interface.

Thereafter, the processor 204 identifies at least one business-task, based on the inputs from the user, which are received at the receiver 202. The inputs from the users can include a selection of one or more business-tasks presented to them in the form of a business-task list. For example, users may want to find the dealer location where they can locate the DVD of the movie. They may select the business-task related to the dealer contact information from the business-task list presented to them. Users may also select more that one business-task simultaneously. Further, if the business-task the users want to perform is not present in the business-task list, they can type the business-task desired by them or can use a business-task dictionary at the electronic device 106 to select a business-task. Furthermore, users can also send a desired business-task as a text message to the business process-enabler portal 108.

The processor 204 can also associate the business-tasks present in the business-task list of the media content with one or more media content present at the media content creator 102. For example, a business-task such as “get information pertaining to car dealer locations” will have the relevant media content stored at the media content creator 102. Similarly, other business-tasks will have their associated media content stored at the media content creator 102. Such stored media content is known as user-desired media content. In such a case, the content IDs of user-desired media contents can be linked to the content ID of the media content. For example, the content IDs of the one or more user-desired media contents associated with the business-tasks are linked to the content IDs of the media content including such business-tasks. For example, if a car advertisement having content ID ‘A1’ contains the business-tasks such as ‘purchase the car’, ‘get information about car loans’, ‘get car dealer information’ and so forth, each of these business-tasks can have a user-desired media content having content IDs ‘B1’, ‘B2’, ‘B3’, respectively. Thus, the content ID ‘A1’ will be associated with the content IDs ‘B1’, ‘B2’, ‘B3’.

In another embodiment the media content creator 102 can be requested to create new media content, corresponding to the business-task, when the business-task selected by the user does not have media content corresponding to it.

The transmitter 210 transmits information pertaining to the at least one business-task to at least the media content creator 102, the media content server 104 or the business process enabler portal 108 when the processor 204 identifies the at least one business-task selected by the user. For example, while watching a movie, the user may be presented with a business-task list that is a graphical user interface with business-tasks such as “get car dealer contact information”, which the user may want to perform. Thereafter, when the user selects the business-task “get car dealer contact information” in an advertisement, information pertaining to the selection can be transmitted to the media content creator 102, the media content server 104 and the business process-enabler portal 108. Therefore, when the media content creator 102 receives information pertaining to the at least one business-task selected by the user, the media content creator 102 can transmit the user-desired media content to at least the media content server 104, the electronic device 106 or the business process-enabler portal 108.

Thereafter, the output unit 206 presents the user-desired media content at the electronic device 106. In an embodiment, whenever users are presented with media content at the electronic device 106, they can opt to watch information they are interested in. Their interest is determined on the basis of the business-task selected by them when the media content was last presented at the electronic device 106. For example, when the advertisement for the car was first presented to the users and they selected the “buy the car” business-task, the next time they are presented with the same advertisement, the user-desired media content corresponding to the “buy the car” business-task is also presented to them. In this case, the user-desired media content can be downloaded or presented live to users of the electronic device 106.

In another embodiment, the user-desired media content can replace the original media content, when the user has already watched the media content that is presented to the users. For example, when the user is watching a car advertisement for a second or a third time, the car advertisement can be replaced with the user-desired media content associated with the business-tasks which the user selected previously while watching the car advertisement. After replacement, the user will be presented with the user-desired media content. Considering the above example, of buying the car, for the second or a third time the user will be presented the information pertaining to buying the car instead of car advertisement.

Further, during live streaming of media content, the processor 204 determines a content ID and a program ID of the user-desired media content which needs to replace the media content. For replacing the media content with the user-desired media content the content ID of the user-desired media content is paired with program ID of the user-desired media content such that the location of the user-desired media content is known. Thereafter, the processor 204 determines the location of the user-desired media content to tune the user-desired media content by using the program ID of the user-desired media content. For example, let the media content ‘A1’ having program ID ‘A123’ is associated with user-desired media content ‘B1’ having program ID ‘B123’, and the user-desired media content ‘B1’ has to be presented to the users because of the selection of the corresponding business-task by the user. The processor will identify the user-desired media content by its content ID ‘B1’. Further, to tune the user-desired media content ‘B1’ it will identify its location by the program ID ‘B123’ as the content ID ‘B1’ is paired with the program ID ‘B123’.

In yet another embodiment, when the business-task selected by the users is completed, they may not be presented with the user-desired media content corresponding to the completed business-task in future. For example, a user selected the business-task “buy the car” the last time the advertisement for the car was presented to him or her, and now the status is that he or she has already bought the car. In this case, the user is not presented with the user-desired media content corresponding to the “buy the car” business-task whenever the advertisement for the car is presented to him or her.

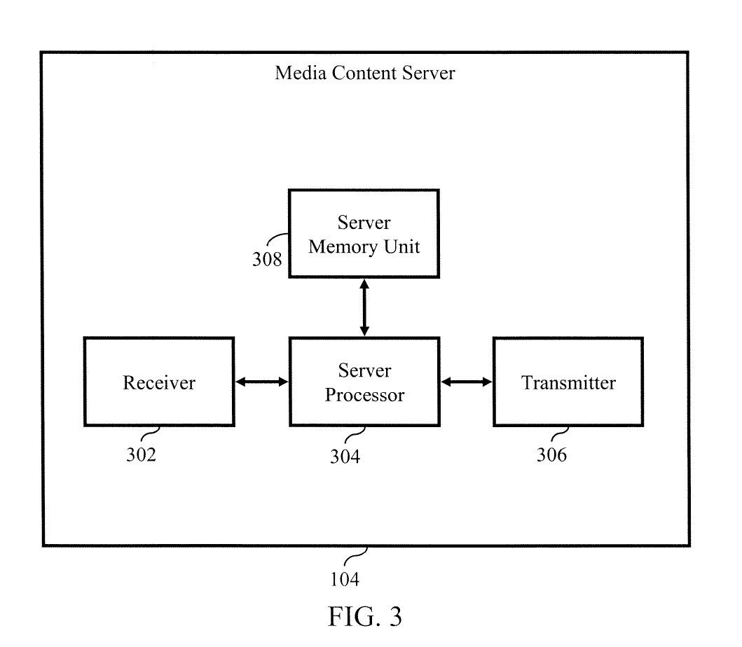

FIG. 3 illustrates a block diagram of a media content server 104, in accordance with an embodiment of the present invention. The media content server 104 manages the media content and/or the user-desired media content at the electronic device 106. Further, the media content server 104 enables the presentation of media content and/or the user-desired media content at the electronic device 106. The media content server 104 includes a receiver 302, a server processor 304 and a transmitter 306. Furthermore, the media content server 104 includes a server memory unit 308 that is configured to store the media content and/or the user-desired media content.

The receiver 302 receives media content to manage the media content and/or the user-desired media content at the electronic device 106. This media content is received from at least the media content creator 102, the business process enabler portal 108 and a server memory unit 308. For example, when the user wants to watch a program on television, the receiver 302 at the cable service provider receives that program in the form of media content. This media content includes a business-task list, which can be a list of business-tasks the user may want to perform while watching a part of or the entire media content. For example, while watching an advertisement for a car, the user may want to know about car loans. Hence, the business-task “know about car loans available” can be included in the business-task list with the advertisement for the car.

The receiver 302 also receives information pertaining to the at least one business-task identified by the user while watching media content at the electronic device 106. For example, while watching an advertisement for a car at the electronic device 106, the user selects the business-task related to the information pertaining to car loans. The receiver 302 receives the information from the electronic device 106.

After receiving the information pertaining to the at least one business-task selected by the user, the server processor 304 selects the user-desired media content, based on the information pertaining to the at least one business-task. The user-desired media content is related to the at least one business-task selected by the user. For example, if the user selects the business-task pertaining to information on car dealer contacts, the server processor 304 selects a video, text, audio or image file with this information. The user-desired media content can be selected from media contents located at the media content creator 102, the business process-enabler portal 108, and/or a server memory unit 308. Thereafter, the media content server 104 enables the transfer of user-desired media content from the business process-enabler portal 108 or from the media content creator 102 to the electronic device 106. In an alternative embodiment, the media content server 104 receives the user-desired media content from the media content creator 102 or the business process-enabler portal 108. Thereafter, it manages the presentation of user-defined media content at the electronic device 106.

The server processor 304 can also associate the media content with one or more media content located at the media content creator 102, the business process-enabler portal 108, and/or a server memory unit 308. This one or more media content relate to the business-task list included in the media content. For example, a business-task such as “get information pertaining to car dealer locations” has associated media content at the media content creator 102 with information pertaining to car dealer locations. Similarly, other business-tasks have associated media content stored at the media content creator 102.

After selecting and receiving the user-desired media content at the media content server 104, the transmitter 306 transmits the user-desired media content to the electronic device 106.

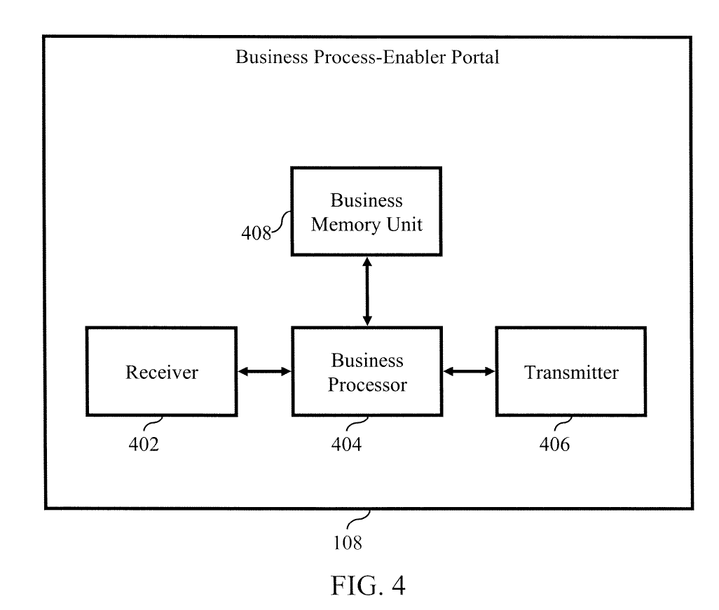

FIG. 4 illustrates a block diagram of a business process-enabler portal 108, in accordance with an embodiment of the present invention. The business process-enabler portal 108 can be a website-hosting machine on the Internet that can facilitate the transfer of media content to the electronic device 106. The business process-enabler portal 108 can also facilitate the business-task requested by the user. Further, the business process-enabler portal 108 can publish information pertaining to the users, media content, the business-task selected by the user, and the user-desired media content. For example, if a user is watching an advertisement for a car, and he or she selects a business-task to obtain information on the car loans available, the business process-enabler portal 108 publishes that the user has selected the business-task pertaining to the car loan as well as the user-desired media content corresponding to it. Further, the business process-enabler portal 108 provides an interface to the service providers, the vendors or the promoters to publish the services offered by them and also retrieve the published information. The advertisers can also upload their content on the business process-enabler portal 108. Moreover, the business process-enabler portal 108 can provide authentication through the user names and passwords of users as well as different advertisers. The business process-enabler portal includes a receiver 402, a business processor 404, a transmitter 406, and a business memory unit 408.

The receiver 402 receives information pertaining to at least one business-task identified by a user at the electronic device 106. For example, while watching an advertisement for a car at the electronic device 106, the user selects the business-task related to the information pertaining to the car loans available. The receiver 402 not only receives the information from the electronic device 106 but can also receive the media content. After receiving information pertaining to at least one business-task, the business processor 404 selects the user-desired media content, based on the information relating to at least one business-task. For example, if the user selects the business-task pertaining to information on car dealer contacts, the business processor 404 selects a video, text, audio or image file with information relating to car dealer contacts.

The business processor 404 enables the transfer of the media content requested by the user from a media content creator 102 to the electronic device 106. The transfer of media content to the electronic device 106 can also take place through the media content server 104 or the business process-enabler portal 108. Moreover, the business processor 404 can publish the information pertaining to the user, the at least one business-task selected by the user, and the media content. This information can be published in a similar manner as any information published on a website. Therefore, users and promoters of the advertisement, with an authentic username and password, can view the published information. This enables promoters of media content to target the media content on the basis of users' interest.

The transmitter 406 transmits the media content to the media content server 104 and the electronic device 106. Further, the transmitter 406 transmits information pertaining to the at least one business-task to the media content creator 102. Thereby, the transfer of user-desired media content to the electronic device 106 is facilitated by the transmission of information pertaining to the at least one business-task. The information relating to the at least one business-task, the media content and the user can also be stored at the business memory unit 408. Users can be provided with a reminder option so that they can be reminded to view the media content stored at the business process-enabler portal 108. The user-desired media content can be streamed to users on a user-defined reminder date.

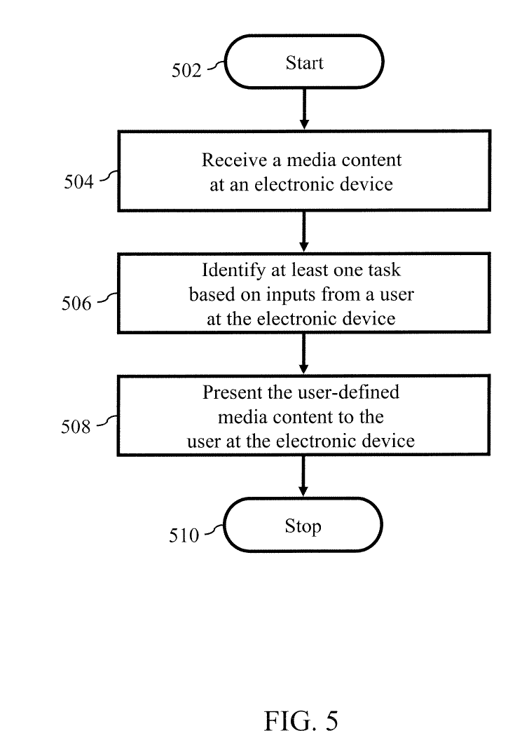

FIG. 5 is a flow diagram illustrating a method for presenting user-desired media content, in accordance with an embodiment of the present invention. This method for presenting user-desired media content is initiated at step 502.

At step 504, the media content is received at the electronic device 106. For example, when a user is watching a program on television, the program is received at the television as media content. This media content includes a business-task list, which includes a list of business-tasks the user may want to perform while watching the media content. For example, while watching a movie clip, the user may want to get information about its director. Therefore, the business-task pertaining to the information about the director of the movie clip is included in the media content. At step 506, at least one business-task is identified from the business-task list, based on inputs from the user. For example, a business-task related to information about the director of the movie clip business-task can be selected by the user. Thereafter, at step 508, the user-desired media content corresponding to the at least one business-task identified is presented to the user at the electronic device 106. For example, the media content containing the information about the director of the movie clip can be presented to the users when they select the business-task corresponding to it. Thereafter, the method terminates at step 510.

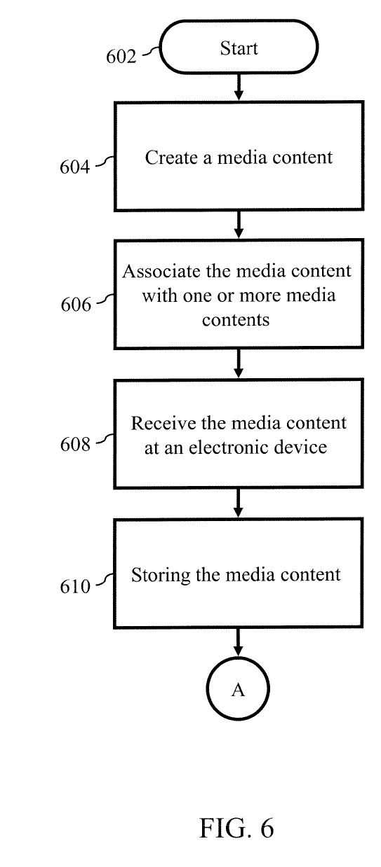

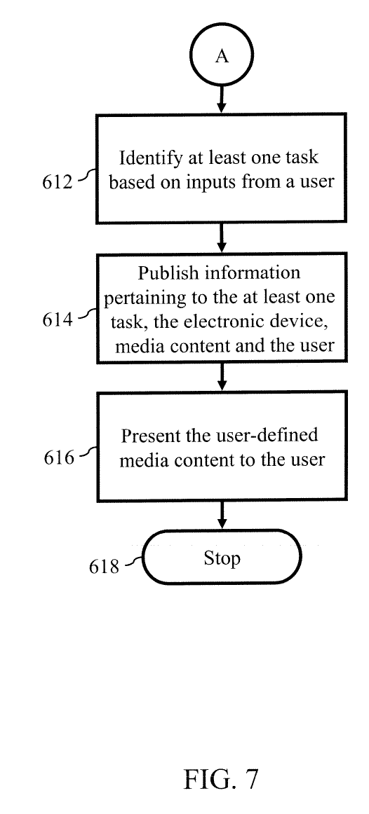

FIGS. 6 and 7 depict another flow diagram illustrating a method for presenting user-desired media content, in accordance with an embodiment of the present invention. The method for presenting user-desired media content is initiated at step 602. At step 604, media content is created. For example, when a program is to be broadcasted to a large number of viewers, it has to be first created at the media content creator 102. The media content creator 102 creates the program such that it includes a business-task list, which is a list of business-tasks users may like to perform while watching the media content. The business-tasks can include all forms of commercial activity that the user can perform. For example, while watching a football match on television, the user may wish to get information about places where tickets are available for the next match. Therefore, in this case getting the information about the purchase of tickets is a commercial activity. The user is presented with a media content which includes a list containing links to media content that will provide the information related to purchasing the tickets. These business-tasks can be different forms of commercial activities include buying, leasing, renting a product, getting more information about the dealers of the product, getting to know other channels running programs similar to the media content being viewed by the user, getting more movies of actor in a particular program or a clip, and so forth. Further, if users want to perform a business-task that is not available in the business-task list, they user can type the business-task or use a business-task dictionary at the electronic device 106, to select a business-task. Thereafter, they can send the business-task as a text message to the business process-enabler portal 108.

At step 606, the media content at the media content creator 102 is associated with one or more media content. This one or more media content is related to the business-tasks present in the business-task list included in the media content, for example, if a movie clip contains business-tasks such as “get more information about the actor”, “find authorized dealers where the DVD of the movie is available”, “locate cinema halls screening the movie”, and so forth. Thereafter, the movie clip is associated with the media content pertaining to the presentation of information about the actor of the movie clip, authorized DVD dealers, and cinema halls screening the movie. The media content is associated with one or more media content, so that when users select at least one business-task, they can be presented with the user-desired media content corresponding to the business-task selected by them.

At step 608, the media content is received at the electronic device 106 so that it can be presented to the user. For example, to present a movie clip to the user at the electronic device 106, the movie clip is received at the electronic device 106 as media content. The media content can be received at the electronic device 106 from the media content creator 102. Further, the media content can be received via the media content server 104 or the business process-enabler portal 108. At step 610, the media content can be stored at the media content server 104, the electronic device 106 and/or the business process-enabler portal 108. For example, streaming media content can be stored at digital video recorders. The media content is stored so that it can be viewed by users in future.

At step 612, at least one business-task is identified, based on the inputs from a user. The at least one business-task includes the business-tasks the user would like to perform while or after watching the media content. For example, while watching a cricket match, the user can select that business-task from a business-task list if he or she wants to know about the sponsors of that match. After the user selects at least one business-task, the at least one business-task can be identified by the processor 204, the server processor 304, and the business processor 404. The information pertaining to the business-task selected by the user is then transmitted to at least the media content creator 102, the business process-enabler portal 108, and/or the media content server 104. This information can be transmitted through a Set Top Box (STB) uplink or by STB Internet Protocol (IP) connectivity. This information can also be transmitted through the user's mobile phone as an SMS. Alternatively, this information can be transmitted by using a Bluetooth™ connection. The information is transmitted so that the media content corresponding to the at least one business-task can be presented to the user. To do this, the business process-enabler portal 108 contacts the media content creator 102. Thereafter, user-desired media content is selected at the media content creator 102. This user-desired media content can be transmitted to the media content server 104, the electronic device 106 and the business process-enabler portal 108.

At step 614, the information pertaining to the at least one business-task selected by the user, the media content, the electronic device and the user is published at the business process-enabler portal 108. These details are published to enable advertisers and promoters of media content to determine the interest of various users, so that the advertisers and promoters can cash in on the business opportunity created. For example, an advertiser who knows that a particular user is interested in buying a car can target this user appropriately to market the car. The business process-enabler portal 108 provides an authentication-based login ID to the advertisers and promoters of the media content, as a feature of the published information.

At step 616, the user-desired media content is presented to users of the electronic device 106. For example, if a user is interested in information related to car loans, and has selected the business-task corresponding to it; he or she is presented with media content at the electronic device 106. The user-desired media content is presented by using the output unit 206, for example, the monitor of a computer. The presentation of user-desired media content can be managed by the media content server 104 or the business process-enabler portal 108. In an embodiment, the user-desired media content can be published at the business process-enabler portal 108, which the user can view by providing an authentic login ID. Moreover, users can use a “remind later” option, in which the business process-enabler portal 108 reminds them to view the user-desired media content. Thereafter, the method terminates at step 618.

Various embodiments of the present invention offer one or more advantages. The media content includes a business-task list, instead of the media content related to business-tasks, as metadata, which requires reduced bandwidth. Further, the inclusion of the business-task list in the metadata of the media content enables users to perform business-tasks while watching the media content. Moreover, targeted and personalized media content delivery is provided to the users, based on their interests and preferences. Additionally, the method helps promoters and vendors of media content to market their products or promotional offers to users, based on the interests and preferences of the users.

It will be appreciated that the method and system for presenting user-desired media content, described herein, may comprise one or more conventional processors and unique stored program instructions that control the one or more processors, to implement, in conjunction with certain non-processor circuits, some, most or all of the functions of the system described herein. The non-processor circuits may include, but are not limited to, signal drivers, clock circuits, power-source circuits and user-input devices. As such, these functions may be interpreted as steps of a method and system for presenting user-desired media content. Alternatively, some or all the functions can be implemented by a state machine that has no stored program instructions, or in one or more application-specific integrated circuits (ASICs), in which each function, or some combinations of certain of the functions, are implemented as custom logic. Of course, a combination of the two approaches can also be used. Thus, methods and means for these functions have been described herein.

It is expected that one with ordinary skill, notwithstanding possibly significant effort and many design choices motivated by, for example, available time, current technology and economic considerations, when guided by the concepts and principles disclosed herein, will be readily capable of generating such software instructions, programs and ICs with minimal experimentation.

In the foregoing specification, the invention and its benefits and advantages have been described with reference to specific embodiments. However, one with ordinary skill in the art would appreciate that various modifications and changes can be made, without departing from the scope of the present invention, as set forth in the claims. Accordingly, the specification and the figures are to be regarded in an illustrative rather than a restrictive sense, and all such modifications are intended to be included within the scope of the present invention. The benefits, advantages, solutions to problems and any element(s) that may cause any benefit, advantage or solution to occur or become more pronounced are not to be construed as critical, required or essential features or elements of any or all the claims. The invention is defined solely by the appended claims, including any amendments made during the pendency of this application, and all equivalents of those claims, as issued.

What is claimed is:

1. A method for presenting user-desired media content to a user, wherein the user-desired media content relates to at least one business-task that the user wants to perform, the at least one business-task including all forms of commercial activity that the user can perform, the method comprising:
receiving a media content at an electronic device, wherein the media content comprises a business-task list, the business-task list including the at least one business-task which the user may want to perform;
identifying the at least one business-task based on inputs from the user at the electronic device; and
presenting the user-desired media content to the user at the electronic device.

2. The method as recited in claim 1 wherein the commercial activity that the user can perform can be selected from a group comprising at least one of:
buying a product or a service;
getting to know an address of a nearest dealer selling a product or a service;
getting to know other channels running programs similar to the media content being viewed by the user;
renting a product or a service;
leasing a product or a service; and
getting more movies of actor in a particular program or a clip.

3. The method as recited in claim 1 further comprising creating the media content such that the media content comprises the business-task list.

4. The method as recited in claim 1 further comprising associating the media content with one or more media contents, wherein the one or more media contents pertain to the business-task list present in the media content.

5. The method as recited in claim 1 further comprising storing the media content at at least one of:
a media content creator;
a media content server;
a business process-enabler portal; and
the electronic device.

6. The method as recited in claim 1, wherein identifying the at least one business-task comprises:
selecting the at least one business-task from the from the business-task list, wherein the selection is made by the user; and
determining the user-desired media content based on the at least one business-task selected by the user.

7. The method as recited in claim 1, wherein presenting the user-desired media content comprises transmitting information pertaining to the at least one business-task to at least one of:
a media content server;
the electronic device;
a business process-enabler portal; and
a media content creator.

8. The method as recited in claim 1 further comprising publishing information pertaining to at least one of:
the at least one business-task;
the electronic device;
the media content; and
the user at a business process-enabler portal.

9. The method as recited in claim 1, wherein presenting the user-desired media content comprises transmitting the user-desired media content from a media content creator to the electronic device.

10. The method as recited in claim 9, wherein the user-desired media content is transmitted to the electronic device through at least one of:
a business process-enabler portal; and
a media content server.

11. The method as recited in claim 1, wherein the media content is received at the electronic device from at least one of:
a media content server;
a media content creator;
a business process-enabler portal; and
an electronic memory unit located at the electronic device.

12. An electronic device capable of presenting user-desired media content to a user, wherein the user-desired media content relates to at least one business-task that the user wants to perform, the at least one business-task including all forms of commercial activity that the user can perform, the electronic device comprising:
a receiver configured to receive a media content, wherein the media content comprises a business-task list, wherein the business-task list comprises the at least one business-task which the user may want to perform;
a processor configured to identify the at least one business-task based on inputs from the user; and
an output unit configured to present the user-desired media content to the user.

13. The electronic device as recited in claim 12 further comprising a transmitter configured to transmit an information pertaining to the at least one business-task.

14. The electronic device as recited in claim 12 further comprising an electronic memory unit configured to store the media content.

15. The electronic device as recited in claim 12, wherein the receiver is further configured to receive inputs from the user.

16. The electronic device as recited in claim 12, wherein the processor is further configured to associate the media content with one or more media contents, wherein the one or more media contents pertain to the business-task list present in the media content.

17. The electronic device as recited in claim 12, wherein the media content is received from at least one of:
a media content server;
a media content creator;
a business process-enabler portal; and
an electronic memory unit located at the electronic device.

18. A business process-enabler portal capable of enabling a transfer of user-desired media content to an electronic device, wherein the user-desired media content relates to at least one business-task that the user wants to perform, the at least one business-task including all forms of commercial activity that a user can perform, the business process-enabler portal comprising:
a receiver configured to receive an information pertaining to the at least one business-task identified by the user at the electronic device; and
a business processor configured to:
select the user-desired media content based on the at least one business-task; and
enable the transfer of the user-desired media content from a media content creator to the electronic device.

19. The business process-enabler portal as recited in claim 18, wherein the receiver is further configured to receive media content, wherein the media content includes a business-task list, the business-task list comprising the at least one business-task that the user may want to perform.

20. The business process-enabler portal as recited in claim 18 further comprising a transmitter configured to transmit media content to at least one of:
a media content server; and
the electronic device.

21. The business process-enabler portal as recited in claim 18 further comprising a business memory unit configured to store:
media content; and
information pertaining to at least one of:
the at least one business-task;
a media content; and
the user.

22. The business process-enabler portal as recited in claim 18, wherein the business processor is further configured to publish the information pertaining to at least one of:
the at least one business-task;
a media content; and
the user.

23. The business process-enabler portal as recited in claim 18 further comprising a transmitter configured to transmit:
the information pertaining to the at least one business-task identified by the user; and
media content.

24. A media content server capable of managing user-desired media content at an electronic device, wherein the user-desired media content relates to at least one business-task that the user wants to perform, the at least one business-task including all forms of commercial activity that a user can perform, the media content server comprising:
a receiver configured to receive an information pertaining to the at least one business-task identified by the user, wherein the user identifies the at least one business-task while viewing a media content at the electronic device;
a server processor configured to select the user-desired media content based on the information pertaining to the at least one business-task; and
a transmitter configured to transmit the user-desired media content to the electronic device.

25. The media content server as recited in claim 24 wherein the commercial activity that the user can perform can be selected from a group comprising at least one of:
buying a product or a service;
getting to know an address of a nearest dealer selling a product or a service;
getting to know other channels running programs similar to the media content being viewed by the user;
renting a product or a service;
leasing a product or a service; and
getting more movies of actor in a particular program or a clip.

26. The media content server as recited in claim 24, wherein the receiver is further configured to receive the media content, wherein the media content comprises a business-task list, the business-task list comprising the at least one business-task which the user may want to perform.

27. The media content server as recited in claim 24 further comprising a server memory unit configured to store the media content.

28. The media content server as recited in claim 24, wherein the server processor is further configured to associate the media content with one or more media contents, wherein the one or more media contents pertain to a business-task list.

29. The media content server as recited in claim 24, wherein the media content is received from at least one of:
a media content creator;
a business process-enabler portal; and
a server memory unit located at the media content server.
